(19) United States
(12) Patent Application Publication
(10) Pub. No.: US 2007/0100263 A1
(43) Pub. Date: May 3, 2007

(54) Mechanical actuator for a vestibular stimulator

(76) Inventor: Daniel M. Merfeld, Lincoln, MA (US)

Correspondence Address: FISH & RICHARDSON PC, P.O. BOX 1022, MINNEAPOLIS, MN, 55440-1022, US

(21) Appl. No.: 11/261,394

(22) Filed: Oct. 27, 2005

(51) Int. Cl. A61H 1/00; A61H 7/00; A61H 19/00

(52) U.S. Cl. 601/84; 601/148; 601/76

(57) ABSTRACT

An apparatus to stimulate a vestibular system. The apparatus comprises an actuator configured to mechanically stimulate the vestibular system, and a control module coupled to the actuator, the control module being configured to provide a control signal that causes the actuator to stimulate the generation of a stationary nerve signal by the vestibular system.

### TECHNICAL FIELD

This invention relates to prostheses, and in particular to a vestibular prostheses.

### BACKGROUND

The ability of human beings to maintain stability and balance is controlled by the vestibular system. This system provides the central nervous system with the information needed to maintain balance and stability.

FIG. 1 is a diagram showing the vestibular system. As shown, the vestibular system includes a set of ring-shaped tubes, referred to as the semicircular canals 102a-c, that are filled with the endolymph fluid. The semicircular canals are formed by a membrane called the membranous labyrinth. Each of the semicircular canals 102a-c is disposed inside a hollow bony tube (not shown in the diagram) called the bony labyrinth that extends along the contours of the semicircular canals. As further shown in FIG. 1, each semicircular canal 102a-c terminates in an enlarged balloon-shaped section called the ampulla (marked 104a-c in FIG. 1). Inside each ampulla is the cupula 106a-c, on which hair cells are embedded. Generally, as the semicircular canals 102a-c rotate due to rotational motion of a head, the endolymph fluid inside the canal will lag behind the moving canals, and thus cause the hair cells on the cupula to bend and deform. The deformed hair cells stimulate nerves attached to the hair cells, resulting in the generation of nerve signals that are sent to the central nervous system. These signals are decoded to provide the central nervous system with motion information. The three canals are mutually orthogonal and together provide information about rotation in all three spatial dimensions.

The other endorgans in the vestibular system are the otolith organs, the utricle and the saccule. These endorgans act as linear accelerometers and respond to both linear acceleration and gravity.

In response to the vestibular nerve impulses, the central nervous system experiences motion perception and controls the movement of various muscles, thereby enabling the body to maintain its balance.

One affliction that affects the vestibular system is Meniere's disease. Meniere's disease is a condition in which the vestibular system, for unknown reasons, suddenly begins varying the pulse-repetition frequency in a manner inconsistent with the patient's motion. This results in severe dizziness. Subsequently, and again for no known reason, the vestibular system begins generating a vestibular signal consistent with the person's spatial orientation, thereby ending the person's symptoms.

To alleviate symptoms of Meniere's disease, electrical prostheses can be used to provide a stationary signal to the brain. This can be achieved by producing a jamming signal, through electrical stimulation, that applies a high-amplitude stationary signal to the vestibular nerve, thereby preventing disorienting variations from being sent to the brain by the vestibular periphery. A description of the use of electrical stimulation of the vestibular system to alleviate Meniere's disease symptoms is provided in U.S. patent application Ser. No. 10/738,920, entitled “Vestibular Stimulator”, filed Dec. 16, 2003, the contents of which are hereby incorporated by reference in their entirety.

### SUMMARY

In one aspect, the invention includes an apparatus to stimulate a vestibular system. The apparatus comprises an actuator configured to mechanically stimulate the vestibular system, and a control module coupled to the actuator, the control module being configured to provide a control signal that causes the actuator to stimulate the generation of a stationary nerve signal by the vestibular system.

In some embodiments the actuator comprises a balloon attached to a catheter, the balloon having a volume that varies in response to the control signal.

In some embodiments the actuator comprises a piezoelectric device, the piezoelectric device being configured to be displaced in response to the control signal.

In some embodiments the actuator comprises a piston, the piston being configured to be displaced in response to the control signal.

In some embodiments the actuator comprises an elastic membrane, the elastic membrane being configured to expand in response to the control signal.

In some embodiments the control signal includes data to control an adjustable frequency, an adjustable amplitude, and/or an adjustable duration of the stationary nerve signal.

In some embodiments the apparatus further comprises a power source electrically coupled to the actuator, and/or the control module.

In some embodiments the control module is configured to generate the control signal in response to a non-stationary signal detected by a sensor positioned proximate to the vestibular system.

In some embodiments the stationary signal includes a pulse train characterized by a constant pulse repetition rate, and/or a sinusoidal signal.

In another aspect, the invention includes a method for stimulating a vestibular system. The method comprises inserting an actuator in mechanical communication with the vestibular system, and causing the actuator to stimulate the generation of a stationary nerve signal by the vestibular system.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is a diagram of part of the vestibular system.

FIG. 2 is a schematic diagram of an exemplary embodiment of a mechanical vestibular prosthesis.

FIG. 3A is a schematic diagram in cross-section of a semicircular canal in the vestibular system.

FIG. 3B is a schematic diagram in cross-section of an embodiment of a piston-based actuator.

FIG. 3C is a schematic diagram in cross-section of an embodiment of an elastic membrane actuator.

FIG. 3D is a schematic diagram in cross-section of an embodiment of a balloon actuator implanted at the exterior of the bony labyrinth.

FIG. 3E is a schematic diagram in cross-section of an embodiment of a balloon actuator implanted at the interior of the bony labyrinth.

FIG. 3F is a schematic diagram in cross-section of the inflated balloon actuator of FIG. 3E.

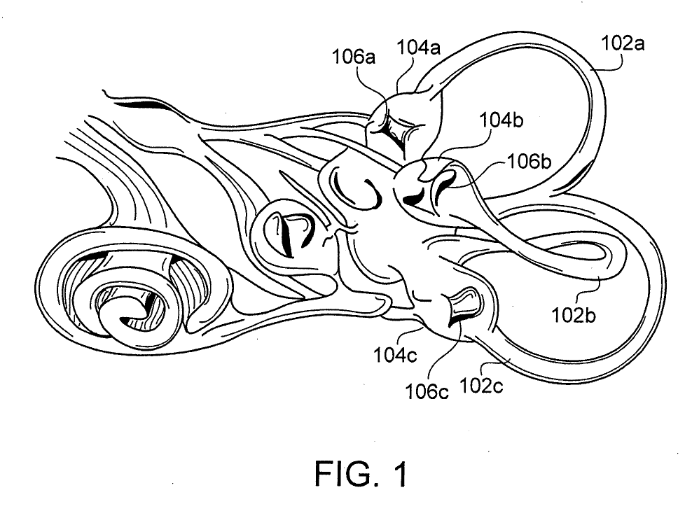

Like reference symbols in the various drawings indicate like elements.

### DETAILED DESCRIPTION

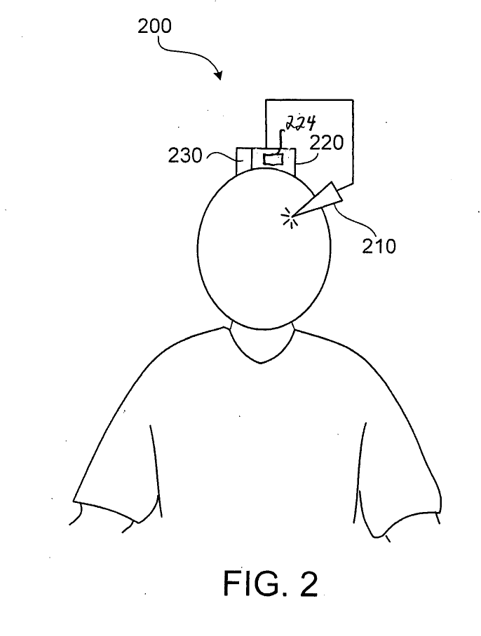

FIG. 2 is a schematic diagram of an exemplary embodiment of a mechanical vestibular prosthesis apparatus 200 adapted to alleviate symptoms of Meniere's disease by applying a stationary signal that is ultimately provided to the central nervous system. The prosthesis 200 includes a mechanical actuator 210 inserted proximate to a semicircular canal to be actuated.

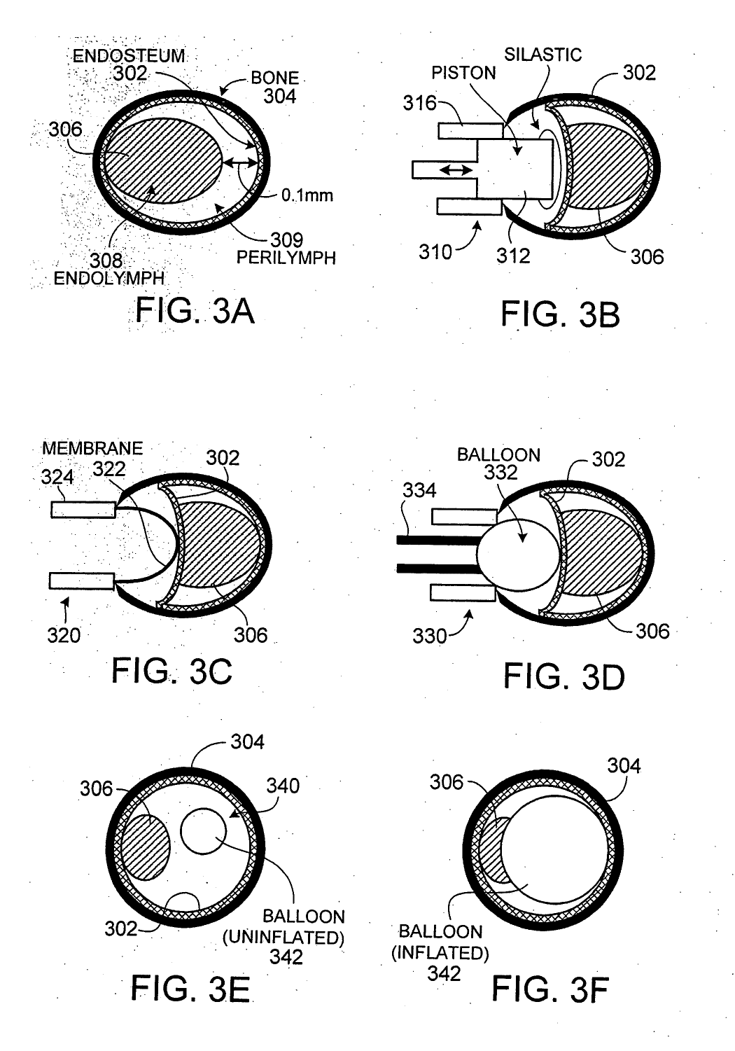

FIG. 3A is a simplified cross-sectional diagram of the semicircular canal that is to be actuated to stimulate the vestibular system and to generate a stationary jamming signal to overwhelm, or mask, the pathological signals due to Meniere's disease. The semicircular canal 306 is formed from the membranous labyrinth. Endolymph fluid 308 fills the canal 306. A bony labyrinth 304 lined with endosteum 302 defines a volume filled with perilymph fluid 309 that surrounds the canal 306. Actuation of the actuator 210 displaces the membranous semicircular canal inside the perilymph-filled volume formed by the bony labyrinth, thereby causing motion of the endolymph. The moving endolymph causes the cilia on the hair cells on the cupula to move or bend in response to the extent of the actuation.

The actuator 210 receives control signals transmitted from the control module 220. Transmission of control signals from the control module 220 to the actuator 210 can be done using wireless transmission. Alternatively, the control signals can be sent from an electrical wire connecting the control module 220 to the actuator 210. The wire can be placed inside a catheter that runs subcutaneously from the control module 220 to the control mechanism of the actuator 210.

FIGS. 3B-3E are various embodiments of the actuator 210. In the embodiment shown in cross-section in FIG. 3B, an actuator 310 includes a piston 312 that is displaced hydraulically inside a cylinder 316. The dimensions of the piston depend on the size of the semicircular canal, which in turn depends on the patient's age and gender. A typical piston diameter for an adult male is 0.3-1.0 mm. Control signals received by the piston's control mechanism (not shown) from the control module 220 (shown in FIG. 2) determine the extent, the frequency, and/or duration of the piston's 312 displacement.

Displacement of the piston depends on the nature of the stimulated signal that is required to mask the symptoms of Meniere's disease. Thus, if a pulse train signal is required, the piston 312 is displaced in the cylinder 316 at a constant frequency and amplitude, thereby causing the vestibular system to generate a stationary signal to be provided to the central nervous system. That stationary signal drowns out, or masks, any time-varying signals produced due to the onset of Meniere's disease, thereby enabling the central nervous system to block out the non-stationary signals produced as a result of Meniere's disease.

As the piston 312 is displaced, it presses against the endosteum 302. This causes the endosteum 302 to be displaced inwardly. The displacement of the endosteum 302 displaces the endolymph in a semicircular canal, thereby causing the hair cells in the cupula to be deflected.

To minimize damage to the endosteum 302 due to the piston's motion, the piston head is covered with a soft biocompatible material 314. A suitable biocompatible material is Silastic.

Since the actuator 310 is implanted, it should be constructed using biocompatible materials. Thus, in some embodiments the piston-based actuator 310 is made of suitable metallic materials such as stainless steel or titanium. Other suitable materials include various types of ceramics that are approved for medical applications.

FIG. 3C shows in cross-section a second embodiment, in which an actuator 320 includes an elastic membrane 322 placed at the end of a cylinder 324. Pressure provided by a pump mechanism (not shown) coupled to the actuator via the cylinder 324 expands the membrane 322 outwardly towards the endosteum, thereby deflecting the endosteum 302. As with the piston-based actuator shown in FIG. 3B, deflection of the endosteum 302 shifts the position of the cupula of the semicircular canal, causing the hair cells on the cupula to be deflected. Additionally, the actuator 320 includes a control mechanism (not shown) adapted to receive control signals from the control module 220. These control signals cause the actuator's pump to pump fluid (gas and/or liquid) to the extent required to cause the vestibular system to generate a stationary signal that would drown out the time-varying signals associated with Meniere's disease.

FIG. 3D shows in cross-section a third embodiment, in which an actuator 330 includes a balloon 332 in fluid communication with a balloon catheter 334. Pressure provided by a pump mechanism (not shown) coupled to the actuator via the catheter 334 expands the balloon 332 outwardly towards the endosteum 302, thereby deflecting the endosteum 302. As with the piston-based actuator 310 shown in FIG. 3B, deflection of the endosteum 302 results in the contraction of the inner volume defined by the endosteum 302, which in turn shifts the semicircular canal, thereby causing the hair cells on the cupula to be deflected. Additionally, the actuator 330 includes a control mechanism (not shown) adapted to receive control signals from the control module 220 to cause the actuator's pump to pump fluid to the extent required to inflate the balloon 332 to cause it to stimulate the vestibular system, thereby causing the vestibular system to generate a stationary signal to drown out the time-varying signals associated with Meniere's disease.

The actuators shown in FIGS. 3B-3D are placed on the exterior of the endosteum. As a result, the endosteum 302 remains intact. This reduces the risk of damage that can otherwise be caused by the presence of an actuator in the perilymph space (i.e., in the volume defined by the bony labyrinth 304 and the endosteum 302).

FIGS. 3E-F show in cross-section a fourth embodiment, in which an actuator is placed inside the perilymph space. As shown in FIG. 3E, an actuator 340 includes a balloon 342 coupled to a balloon catheter (not shown). The balloon 342 is constructed of a material that is durable, non-porous, has good elongation properties (e.g., greater than 250% of the original size of the balloon), and has proper tensile strength. Examples of such materials include latex, polyurethane, and silicone elastomers. It should be noted that if latex is selected as the material of choice for constructing the balloon 342, then medical grade latex, in which proteins causing allergic reactions have been removed, should preferably be used. The balloon 342 generally has a length of about 1 mm, an inflated circular cross-section diameter of 0.7-1 mm, and a deflated circular cross-section diameter of approximately 0.2-0.3 mm.

The balloon catheter is inserted into the perilymph space by cutting a small opening through the bony labyrinth 304 and the endosteum 302. The balloon catheter may subsequently be inserted into the perilymph space using a micromanipulator. After insertion of the balloon catheter, the openings in the bony labyrinth and endosteum are sealed and allowed to heal.

The actuator 340 also includes a larger diameter catheter (also not shown) located outside the bony labyrinth. This larger diameter catheter is coupled to the smaller catheter that was inserted into the perilymph space. The larger catheter runs subcutaneously to a closed container in which a pump mechanism, a fluid reservoir for inflating the balloon, and a control mechanism to control the actuation of the balloon 342 are all located. The pump mechanism, fluid reservoir, and the control mechanism are of conventional design and are therefore omitted from FIGS. 3E-F for the sake of clarity.

The control mechanism for the balloon actuator shown in FIGS. 3E-F is adapted to receive control signals from the control module 220. These control signals cause the pump to pump fluid into the balloon 342. The balloon 342 thus stimulates the vestibular system to generate a stationary signal to drown out the time-varying signals associated with Meniere's disease.

Thus, with reference to FIG. 3F, the pump mechanism directs pressurized gas or liquid from the fluid reservoir through the interconnected catheters. This fluid inflates the balloon 342 inside the perilymph space, thereby deflecting the cupula of the semicircular canal 306. The deflection of the semicircular canal 306 in turn causes the deflection of the hair cell on the cupula. To deflate the balloon, the pump mechanism withdraws the gas/liquid pumped into the balloon 342.

The fluid reservoir used to inflate the balloon should have enough fluid to ensure that the balloon-based actuator 340 would continue operating notwithstanding any fluid leakage. In some embodiments the reservoir has enough fluid to fill a volume 10,000 times that occupied by the inflated balloon 342. The fluid reservoir is preferably equipped with a recharging mechanism so that when the fluid level in the reservoir dips below a certain threshold level, the reservoir can be recharged to ensure continued operation of the actuator 340.

The use of the pump mechanism together with the fluid reservoir described in relation to the actuator 340 can also be used to actuate the balloon-based actuators shown in FIGS. 3C and 3D.

Yet another embodiment shown in FIG. 2, is one based on a piezoelectric device. Transmitting signals, corresponding to a jamming signal, from the control module 220 to a piezoelectric device, which is placed proximate to the endosteum, causes the piezoelectric device to be displaced in accordance with the level of the signal it receives, thereby perturbing the endosteum 302. Perturbation of the endosteum 302, which causes the endosteum to retract and expand, causes the cupula of the semicircular canal 306 to shift. This in turn causes the hair cells on the cupula to deform and send nerve signals to the central nervous system. Alternatively, the piezoelectric device could be used to push fluid to activate any of the balloon-like actuators 322 332, 342 discussed previously. Alternatively, the piezoelectric device can push a piston directly on the endosteum.

Yet another embodiment uses a magnetic field created by a coil of wire to move a piston electromagnetically, which, in turn, pushes fluid to activate any of the balloon-like actuators 322 332, 342 discussed previously. Alternatively, the piston moved by the magnetic coil could push directly on the endosteum 302.

Other types of actuators for actuating the semicircular canal to cause the generation of stationary signals that are sent to the central nervous system are also possible.

As noted above, and as can be seen from FIGS. 3B-3F, the actuator is adjacent to the endosteum 302 (either outside the endosteum, or inside the perilymph space). Placement of the actuator either outside or inside the endosteum 302 generally includes a surgical procedure to, among other things, remove part of the bony labyrinth shielding the endosteum. Thus, performance of such a surgical procedure would generally require that at least local anesthesia be used.

As further shown in FIG. 2, coupled to the actuator 210 is a control module 220 that controls the mechanical actuation of the actuator 210, including the amplitude, frequency, and/or duration of the actuations performed by the actuator 210. Control signals generated by the control module 220 are transmitted to the actuator 210. As previously noted with respect to the various embodiments shown in FIGS. 3B-F, the actuator 210 includes a receiver that receives the control signals and a control mechanism that, in accordance with the received control signals, produces the actuations.

The control module 220 includes a computing device 224 configured to generate control signals to control the actuator 210 to produce a jamming signal for symptomatic relief of Meniere's disease.

The jamming signal characteristics are selected to cause the vestibular system to generate a stationary signal which in effect drowns out the time-varying signals produced by the malfunctioning vestibular system of the patient suffering from Meniere's disease.

One such jamming signal is a high-frequency sinusoid signal having a frequency greater than around 350 Hz. Another jamming signal is a pulse train having controllable pulse amplitude and a pulse repetition frequency. The jamming signal causes the mechanical actuator 210 to displace the endosteum 302 in a controlled pattern, thereby stimulating the nerves of the vestibular system. This mechanical stimulation causes the nerves to generate a nerve signal having a constant pulse-repetition frequency. Such a signal has a substantially constant spectrum. In one embodiment, the pulse-repetition frequency is approximately equal to the maximum neuron firing rate, which is typically on the order of 450 Hz. This pulse-repetition frequency is likely to result in the firing of neurons at or near their maximum firing rate. However, it may be useful in some cases to have a much higher pulse-repetition frequency, for example in the 1-10 kilohertz range, so that neurons fire more asynchronously.

The control signals may be used to cause the actuator 210 to produce other oscillatory jamming signals to stimulate the vestibular system nerves.

The jamming signal need only be present during an attack of Meniere's disease. When the attack subsides, the jamming signal is removed and the patient regains normal vestibular function. The computing device 224 thus includes a signal-suspension mechanism for applying and suspending the generation of the jamming signal.

In one example, the computing device 224 has a patient-accessible switch located on a user interface (not shown) connected to the control module 220. When the patient feels the onset of a Meniere's disease attack, he uses the switch to apply the jamming signal. A disadvantage of this type of control unit is that because the jamming signal masks the symptoms of the attack, the patient is unable to tell whether the attack is over. Consequently, in this embodiment the patient uses the switch to turn off the jamming signal after a reasonable time has elapsed. The resulting change in the pulse-repetition frequency of the signal received by the brain may result in some dizziness. However, if the attack of Meniere's disease is in fact over, this dizziness should abate shortly. If the dizziness does not abate, the patient uses the switch to turn the jamming signal on again.

Alternatively, the signal-suspension mechanism of the computing device 224 can include a timer that automatically turns the jamming signal off after the lapse of a pre-determined jamming interval. In some embodiments, the length of the jamming interval is user-controlled and can be entered through the user interface, whereas in others, the length of the jamming interval is hard-wired into the control unit. If the dizziness does not fade after the jamming signal has been turned off, the patient uses the switch on the user interface to turn the jamming signal on again.

In some embodiments, the control module 220 includes a sensing unit having one or more sensors (not shown) that are implanted proximate to the vestibular system to measure the vestibular signal. Upon detection of time-varying changes in the pulse-repetition frequency of the vestibular signal indicative of the onset of an episode of Meniere's disease, the sensing unit causes the computing device 224 to generate the jamming control signal. This jamming control signal is transmitted to the mechanical actuator 210 to actuate the mechanical displacement of the actuator 210, which in turn stimulates the vestibular system. In this case, the jamming signal characteristics can be made to vary in response to the characteristics of the measured vestibular signal.

The computing device 224 can transmit a one-time signal that causes the actuator 210 to mechanically actuate at a constant repetition rate, thereby stimulating the vestibular nerves to produce nerve signals at a constant pulse repetition frequency. When the symptoms of Meniere's disease subside, the computing device 224 can generate a signal that causes the actuator 210 to suspend its mechanical actuation.

Alternatively, the control signals sent to the actuator 210 can be sent as short bursts separated by pre-determined intervals (e.g., every 10 ms). Control signals sent as short bursts can carry information regarding the level, duration and/or frequency of the mechanical actuation. For example, based on fluctuating signal levels provided at set intervals by the sensors used to detect the onset of an episode of Meniere's disease, the computing device 224 determines corresponding control signals representing an adjustable amplitude value, frequency value, and/or time duration to be sent to the actuator 210. The signals sent at set intervals thus enable the actuator 210 to vary the stimulation of the vestibular system in response to changing characteristics of the detected non-stationary signals produced as a result of Meniere's disease.

The computing device 224 may include a computer and/or other types of processor-based devices suitable for multiple applications. Such devices can include volatile and non-volatile memory elements, and peripheral devices to enable input/output functionality. Such peripheral devices include, for example, a CD-ROM drive and/or floppy drive, or a network connection, for downloading software containing computer instructions. Such software can include instructions to enable general operation of the processor-based device. Such software can also include implementation programs to generate control information for controlling the mechanical actuation of the actuator 210. The computing device 224 may include a digital signal processor (DSP) to perform the various processing functions described above. A suitable DSP is the Analog Devices ADSP 2183 processor.

In many implementations the computing device 224 is placed on the person's head. However, the location of the computing device 224 is not critical. The device 224 can thus be placed anywhere on or off the person's body.

As noted above, the control device 220 also includes a user interface (not shown) to enable a user (such as the person wearing the actuator 210, a physician, or a technician) to directly control the actuator 210. Input entered through the user interface is processed by the computing device 224 to generate corresponding control signals for the actuator 210. Typical user interfaces include a small key pad to enable the user to enter data, and/or a switch for activating or suspending the generation of a jamming signal. Such a key pad, and/or switch, could be attached to a housing in which the computing device 224 is held. However, the user interface need not be located proximate to the computing device 224. For example, a computer console can be remotely linked to the computing device 224, either using wireless or wired transmission. Executing on such a computer console would be, for example, a graphical user interface to enable the user to enter the data for controlling the actuator 210.

FIG. 2 further shows that the prosthesis 200 includes a power source 230 to power the computing device 224 and/or the actuator 210. The power source 230 may be a battery carried by or attached to the person. The power source 230 is electrically coupled to the control module 220 and/or the actuator 210 using electrical conducting wires. Alternatively, powering of the control module 220 and the actuator 210 may be implemented via wireless power transmission. In some embodiments the power source 230 may include several independent power units. For example, a battery for delivering sufficient power to the control module 220 could be connected directly to the control module 220 via electrical wires. A separate power unit, at a different location, could be used, to deliver power to the actuator 210 using power telemetry.

Typically, the prosthesis 200 has to be calibrated. Calibration of the prosthesis 200 includes calibrating the level of mechanical actuation that would result in a stationary signal suitable for masking the time-varying signals produced as a result of Meniere's disease. One way to calibrate the prosthesis is to wait for an episode of Meniere's disease. During such an episode, one then manually varies the level of actuation of the actuator 210 (e.g., the amplitude and frequency at which the piston 312 is displaced in cylinder 316) until the actuation is such that symptoms disappear. The actuator 210 may also be calibrated to produce levels of actuations that depend on the level and nature of the non-stationary vestibular signals detected by the sensors configured to detect the onset of an episode of Meniere's disease.

In operation, the computing device 224 generates signals to control the level of mechanical actuation. The mechanical actuations produced by actuator 210 stimulate the nerves of the vestibular system, thereby causing the vestibular system to generate stationary nerve signals that drown out, or mask, the non-stationary signals produced as a result of Meniere's disease. Generation of control signals by the computing device 224 can be triggered either automatically, when a sensing device senses the onset of an attack of Meniere's disease, or manually when the patient, or some other individual, operates a switch that causes the computing device 224 to generate and transmit the control signals to control the operation of actuator 210.

Although FIG. 2 shows only a single actuator 210, additional actuators may be used. For example, an additional actuator (not shown in the figure) may be placed so as to activate another semicircular canal. Further, the actuator 210 may be used in conjunction with other types of stimulators and/or actuators. For example, the stimulator described herein may be used with the optical stimulator described in U.S. patent application Ser. No. 11/227,969, entitled “Optical Vestibular Stimulator,” filed Sep. 14, 2005, the contents of which are hereby incorporated herein by reference in their entirety, and/or with the various stimulators (e.g., electrical, chemical, etc.) described in U.S. patent application Ser. No. 10/738,920.

Further, although FIG. 2 shows the apparatus 200 being used with a human being, the apparatus 200 can also be used with animals. The prosthesis 200 can be used both to alleviate medical conditions affecting a person's balance and stability, and for other conditions in which stimulation of the vestibular system is required or desirable. Further, the apparatus 200 may be used for non-therapeutic or even non-medical purposes. For example, the apparatus 200 can be used in the course of medical research to investigate the functioning of the brain.

### Other Embodiments

A number of embodiments of the invention have been described. Nevertheless, it will be understood that various modifications may be made without departing from the spirit and scope of the invention. Accordingly, other embodiments are within the scope of the following claims.

What is claimed is:

1. An apparatus to stimulate a vestibular system, the apparatus comprising:
an actuator configured to mechanically stimulate the vestibular system; and
a control module coupled to the actuator, the control module being configured to provide a control signal that causes the actuator to stimulate the generation of a stationary nerve signal by the vestibular system.

2. The apparatus of claim 1, wherein the actuator comprises a balloon attached to a catheter, the balloon having a volume that varies in response to the control signal.

3. The apparatus of claim 1, wherein the actuator comprises a piezoelectric device, the piezoelectric device being configured to be displaced in response to the control signal.

4. The apparatus of claim 1, wherein the actuator comprises a piston, the piston being configured to be displaced in response to the control signal.

5. The apparatus of claim 1, wherein the actuator comprises an elastic membrane, the elastic membrane being configured to expand in response to the control signal.

6. The apparatus of claim 1, wherein the control signal includes data to control at least one of an adjustable frequency, an adjustable amplitude, and an adjustable duration of the stationary nerve signal.

7. The apparatus of claim 1, further comprising a power source electrically coupled to at least one of: the actuator, and the control module.

8. The apparatus of claim 1, wherein the control module is configured to generate the control signal in response to a non-stationary signal detected by a sensor positioned proximate to the vestibular system.

9. The apparatus of claim 1, wherein the stationary signal includes at least one of: a pulse train characterized by a constant pulse repetition rate, and a sinusoidal signal.

10. A method for stimulating a vestibular system, the method comprising:
inserting an actuator in mechanical communication with the vestibular system; and
causing the actuator to stimulate the generation of a stationary nerve signal by the vestibular system.

11. The method of claim 10, wherein causing the actuator to stimulate comprises:
producing a control signal; and
transmitting the control signal to the actuator.

12. The method of claim 10, wherein causing the actuator to stimulate comprises displacing a semi-circular canal of the vestibular system.

13. The method of claim 10, wherein causing the actuator to stimulate comprises causing a balloon to change its volume.

14. The method of claim 10, wherein causing the actuator to stimulate comprises causing a piezoelectric device to be displaced.

15. The method of claim 10, wherein causing the actuator to stimulate comprises causing a piston to be displaced.

16. The method of claim 10, wherein causing the actuator to stimulate comprises causing an elastic membrane to expand.

17. The method of claim 10, wherein causing the actuator to stimulate comprises at least one of setting an adjustable frequency of the actuator, setting an adjustable amplitude of the actuator, and setting a duration of actuation of the actuator.

18. The method of claim 11, wherein producing the control signal comprises:
detecting a non-stationary signal produced by the vestibular system; and
producing the control signal in response to the detected non-stationary signal.

19. The method of claim 10, wherein the stationary signal includes at least one of: a pulse train characterized by a constant pulse repetition rate, and a sinusoidal signal.
